(19) United States
(12) Patent Application Publication
(10) Pub. No.: US 2003/0188272 A1
(43) Pub. Date: Oct. 2, 2003

(54) Synchronous assert module for hardware description language library

(76) Inventors: Peter Korger, Frederick, CO (US); Christopher M. Giles, Lafayette, CO (US)

Correspondence Address: Sandeep Jaggi, Ph. D, LSI LOGIC CORPORATION, M/S D-106, 1551 McCarthy Boulevard, Milpitas, CA, 95035, US

(21) Appl. No.: 10/107,961

(22) Filed: Mar. 27, 2002

(51) Int. Cl. G06F 17/50

(52) U.S. Cl. 716/4

(57) ABSTRACT

A hardware description language (HDL) module is provided, which includes at least one input and output, including a clock input, a plurality of logic statements that define a function of the module, and a logic signal which is available within the module. The module further includes a synchronous assert check, which checks a state of the logic signal against a condition only during a predefined time window within a period of the clock input.

### FIELD OF THE INVENTION

The present invention relates to testing integrated circuit designs, and more specifically to simulating a design written in a hardware description language.

### BACKGROUND OF THE INVENTION

Semiconductor integrated circuits are traditionally designed and fabricated by first preparing a hardware description language (HDL) specification of a logical circuit at the register-transfer level (RTL) in which functional elements are interconnected to perform a particular logical function. A variety of different hardware description languages are available for coding RTL descriptions, such as the Verilog Hardware Description Language, the Altera Hardware Description language (AHDL), and VHDL.

An HDL specification typically includes one or more modules that have been selected from an HDL module library. Each module typically defines a high level circuit function, such as a central processing unit, a memory, a direct memory access controller, a moving picture experts group (MPEG) decoder, and collections of combinational logic. Modules of lower level logical functions can also be included as modules in the library. In addition, the logic designer may create several unique HDL modules that are more application specific.

Once the HDL specification is created, the specification is synthesized into cells of a specific cell library for the technology in which the integrated circuit will be fabricated. Each cell corresponds to a logical function unit, which is implemented by one or more transistors. The cells in the cell library are defined by cell library definitions. Each cell library definition includes cell layout definitions and cell characteristics.

A series of computer-aided design tools generate a netlist of the selected cells and the interconnections between the cells. The netlist is used by a floor planner or placement tool to place the select cells at particular locations in an integrated circuit layout pattern. The interconnections between the cells are then routed along predetermined routing layers. A timing tool is then used to identify any timing violations within the circuit. Once any timing violations have been corrected, the netlist, the cell layout definitions, the placement data and the routing data together form an integrated circuit layout definition, which can be used to fabricate the integrated circuit.

In order to shorten the length of the design process, initial functional tests are often performed on the HDL specification prior to logic synthesis. Any functional errors identified at this stage of the design process can be corrected easily by modifying the HDL specification. A simulation tool is used to simulate the response of the HDL specification to one or more input test vectors. The test vectors are selected to achieve a good functional test of the HDL specification. Selected outputs and intermediate signals generated in response to the test vectors are monitored and compared with expected results. Differences between the simulated results and the expected results are flagged as errors.

Such testing is often referred to as “de-bugging”. However, de-bugging an integrated circuit design written in HDL can be a non-trivial task. For example, a particular signal can be buried in a low level of the design hierarchy and be difficult to monitor. If the signal eventually feeds an output pin, intermediate logic can mask logic errors occurring on that signal. To simplify this process, logic designers often add “assert checks” within the HDL specification to flag when certain error conditions occur. For example, an assert check could continuously monitor a clock signal and generate an error flag whenever the clock signal enters an unknown state. Other assert checks could flag that a particular signal has a selected logic state under certain conditions. The particular condition would be defined by the logic designer.

With current approaches, assert checks monitor the condition on a signal continuously. Monitoring a condition on a signal continuously has the potential to flag errors falsely. Often, the state of the signal being checked only needs to be checked at a certain time within the clock period. For example, certain signals need to be valid only at certain times within the clock period. These signals do not have to obey the specified condition during the remaining time of the clock period.

Improved test methods are therefore desired for testing integrated circuit designs written at the register-transfer level in HDL to reduce the number of false errors that are flagged.

### SUMMARY OF THE INVENTION

One embodiment of the present invention is directed to a hardware description language (HDL) module, which includes at least one input and output, including a clock input, a plurality of logic statements that define a function of the module, and a logic signal which is available within the module. The module further includes a synchronous assert check, which checks a state of the logic signal against a condition only during a predefined time window within a period of the clock input.

Another embodiment of the present invention is directed to a method of testing an HDL specification which includes a plurality of HDL modules. The method includes: (a) applying a test vector to a software model defined by the HDL specification; (b) simulating a response of the software model, including a response of a logic signal generated by the software model, to the test vector over at least one period of a clock signal; and (c) checking a state of the logic signal against a condition during only a predefined time window within a period of the clock signal, wherein the predefined time window is less than the clock period; and (d) generating an error flag if the logic state satisfies the condition during the time window, but not if the logic state satisfies the condition outside of the time window only.

Another embodiment of the present invention is directed to an HDL module, which includes at least one input and output, a plurality of logic statements that define a function of the module, a clock signal which is available within the module, a logic signal which is available within the module, and synchronous assert check for checking a state of the logic signal against a condition only during a predefined time window within a period of the clock input.

Yet another embodiment of the present invention is directed to an HDL library, which includes a plurality of HDL function modules and a synchronous assert check module. The synchronous assert check module includes a signal input, a clock input having a clock period, and a condition statement. The condition statement identifies a condition against which a state of the logic signal is compared and a time window within the clock period during which the condition statement is executed. The time window is less than the clock period.

### BRIEF DESCRIPTION OF THE DRAWINGS

FIG. 1 is a schematic diagram illustrating a register-transfer level (RTL) design process using a hardware description language (HDL) according to one embodiment of the present invention.

FIG. 2 is a schematic diagram illustrating software simulation of an HDL specification according to one embodiment of the present invention.

FIG. 3 is a diagram illustrating an example of a typical HDL assert check module of the prior art.

FIG. 4 is a diagram illustrating an example of an HDL assert check module of the present invention.

FIG. 5 is a logic diagram of a simple logic block which can be defined as an HDL module and can include a synchronous assert check in accordance with one embodiment of the present invention.

FIG. 6 is a diagram illustrating a Verilog HDL module instance which defines the logical function block shown in FIG. 5 and includes a synchronous assert check, according to one embodiment of the present invention.

FIG. 7 is a waveform diagram illustrating an example of waveforms applied to the module shown in FIG. 6 and signals generated by the module during simulation.

### DETAILED DESCRIPTION OF ILLUSTRATIVE EMBODIMENTS

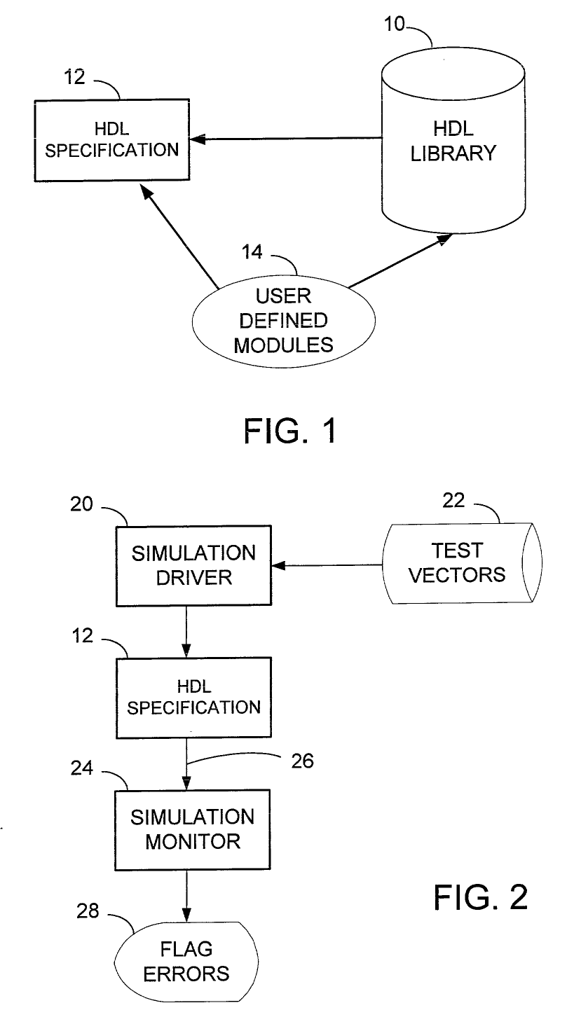

FIG. 1 is a schematic diagram illustrating a register-transfer level (RTL) design process according to one embodiment of the present invention During the design process, the logic designer selects predefined functional modules from a hardware description language (HDL) library 10 and instantiates those modules into an HDL specification 12 for implementing a particular integrated circuit design. HDL library 10 can include a variety of different types of modules, such as high-level functional units including a memory, a central processing unit, an MPEG decoder, a direct-memory access (DMA) controller and large sections of combinational logic. Lower-level functional units can also be included as modules in library 10. Virtually any integrated circuit function can be implemented as a module within HDL library 10. In addition to the modules contained in library 10, the logic designer can create one or more additional modules 14, which can be added directly to HDL specification 12 or added in library 10 and instantiated in HDL specification 12. Each module is written in a software code according to the particular HDL language being used. Examples of presently used HDL languages include the Verilog Hardware Description Language, VHDL and the Altera Hardware Description Language (AHDL). Other languages can also be used. The inputs and outputs of the selected module instances are coupled together to form the overall HDL specification 12.

Prior to synthesizing HDL specification 12 into cells of a specific cell library, a software simulation is often performed on the HDL specification to identify any potential errors or design rule violations. Software simulation is shown schematically in FIG. 2. A simulation driver 20 generates one or more test vectors 22 which are applied to the inputs and/or internal registers or components of HDL specification 12. These vectors 22 are applied to HDL specification 12, and the HDL specification is then “clocked” for one or more clock cycles. A simulation monitor 24 extracts output vectors 26 from the simulation and checks these output vectors against expected results a list of design rules. Again, output vectors 26 can include outputs from HDL specification 12 and/or outputs or wires internal to the specification. Simulation monitor 24 outputs the flagged errors 28. Flagged errors 28 can be provided as outputs to a user display, a simulation log or any other output device, and can be used to trigger termination of the simulation if desired.

In order to simplify simulation of an HDL specification, logic designers often add assert checks to one or more modules within the HDL specification to detect when a certain condition occurs. An assert check typically generates an additional test output that would normally not be present and can be monitored by simulation monitor 24. The assert check sets (or alternatively resets) the test output if a predefined condition is satisfied. For example, an assert check could set a flag whenever an internal clock signal is in an unknown state.

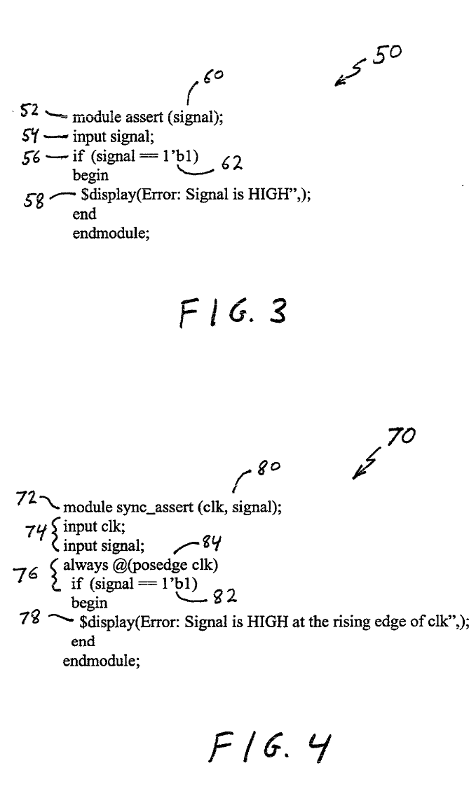

An example of a typical assert check module of the prior art is shown in FIG. 3. Assert check module 50 is written in Verilog HDL and includes a module name statement 52, an input statement 54, a condition statement 56 and a flag statement 58. Module name statement 52 identifies the name of the module, which in this case is “assert”, and identifies all inputs and outputs 60 to the module. In this example, module assert has a single input named “signal”. Input statement 54 declares that the input signal is an input to the module. Condition statement 56 defines a condition 62 against which the signal is compared. In this example, condition 62 is “1′b1”, which indicates a 1-bit wide binary value of “1”. If “signal” has a binary logic state of “1”, flag statement 58 displays the error message, “Error: signal is HIGH”.

Assert check module 50 can be instantiated within HDL specification 12 to check whether a particular signal within the specification becomes a logic 1. A disadvantage of assert check module 50 is that it monitors the logic state of the “signal” continuously. If the signal only has to be a “0” at a certain time within a clock period, such as at the rising or falling edge of the clock, then assert check module 50 has the potential of falsely flagging an error. If the signal temporarily becomes a “1” outside the critical time window, an error will be flagged.

With the present invention, these false errors can be avoided by performing the assert checks synchronously with the clock. In one embodiment of the present invention, the signal being monitored is only checked during a certain time window within a clock period. For example, the logic state of the signal can be checked only at the rising or falling edge of the clock signal. By monitoring the signal only during a certain time window in a clock period, the flagging of false errors can be avoided for signals that only need to satisfy the condition at a particular time.

FIG. 4 is a diagram illustrating an example of a synchronous assert check module according to one embodiment of the present invention. Synchronous assert check module 70 includes a module name statement 72, input statements 74, a condition statement 76 and a flag statement 78. Name statement 72 identifies the name of the module as “sync_assert”, and identifies the inputs and outputs 80 as including “CLK” and “signal”. Input statements 74 declare CLK and signal as inputs to module 70. Condition statement 76 defines a condition 82 against which the signal is compared and defines a time window 84 during which the signal is monitored. As in the example shown in FIG. 3, module 70 checks whether the signal has a logic “1” state. However, this state is only monitored during time window 84, which in this example is at the positive edge of the clock signal, CLK. The value of the signal at all other times in the clock period is ignored. Only if the signal has a logic “1” state at the positive edge of the clock signal does module 70 execute flag statement 78 to display the error message, “Error: signal is HIGH at the rising edge of CLK.” In an alternative embodiment, module 70 also includes a finish statement following flag statement 78, which terminates the simulation if a fatal error occurs.

Although in FIG. 4 the synchronous assert check is performed on the rising edge of the clock, the check could be done at the falling edge of the clock or during any other time window or time instant within the clock period, depending on the particular application. Also, the condition against which the signal is checked can include any condition that can be detected at the RTL level. For example, the condition can be the signal having a logic “1” state, a logic “0” state, a tri-state level or an unknown state. In addition, more complex conditions can also be used, which check the state of the signal at the specified time window when the states of one or more other signals within the HDL specification satisfy some condition.

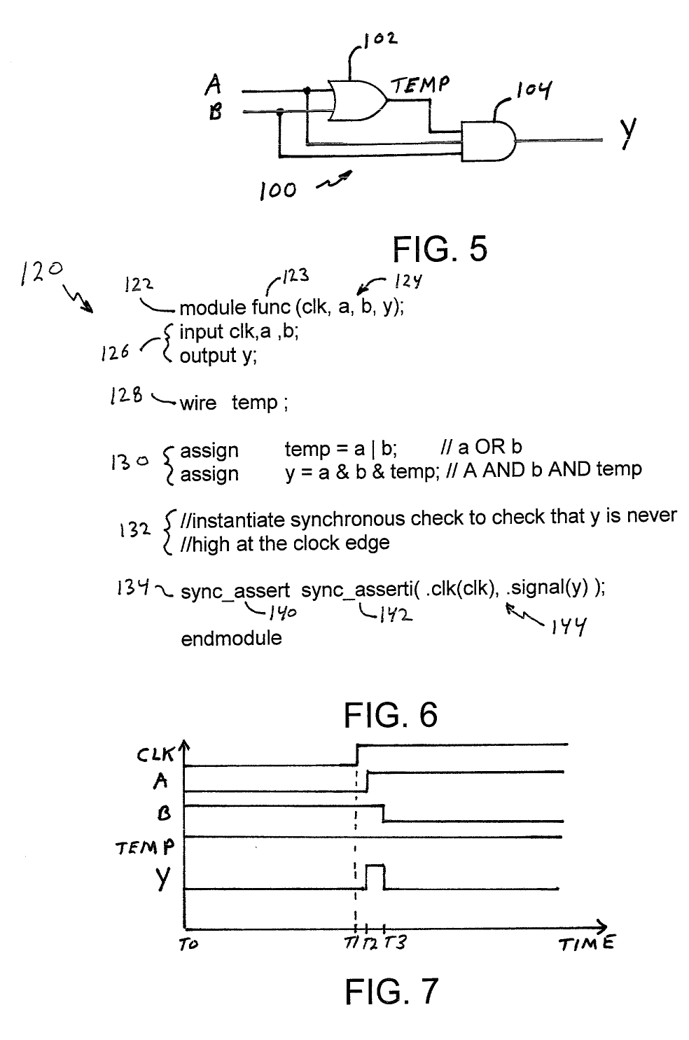

FIG. 5 is a logic diagram of a simple logic block which can be defined as an HDL module and can include a synchronous assert check in accordance with one embodiment of the present invention. Logic block 100 has a logic-OR function 102 and a logic-AND function 104. Inputs A and B are applied to the inputs of OR function 102. The output of OR function 102, labeled TEMP, and inputs A and B are applied to the inputs of AND function 104. The output of AND function 104 is labeled “ay”.

FIG. 6 is a diagram illustrating a Verilog HDL module which is written to define logical function block 100 and to include a synchronous assert check of signal Y at the rising edge of the clock, according to one embodiment of the present invention. Module 120 has a module name statement 122, with name 123 and inputs and outputs 124, input-output statements 126, a wire statement 128, logic statements 130, comment lines 132 and synchronous assert statement 134. In this example, module name 123 is “FUNC”. The signals, CLK, A, B and Y, are inputs and outputs to module 120. Input-output statements 126 declare that CLK, A and B are inputs to the module, and Y is an output from the module. Wire statement 128 defines an internal wire “TEMP” within module 120. Logic statements 130 define the logic function performed by module 120. The value of TEMP is defined as the logical OR of A and B, which implements the logic function 102 shown in FIG. 5. The value of Y is defined as the logical AND of A, B and TEMP, which implements the logic function 104 shown in FIG. 5.

Synchronous assert statement 134 instantiates an instance of the synchronous assert module shown in FIG. 4 within module 120. Synchronous assert statement 134 includes a module name 140, which identifies the module within the HDL library that is being instantiated, and an instance name 142, which identifies the name of the particular instance of the module within the HDL specification. Input-output map 144 lists the inputs and outputs to the module being instantiated and maps those inputs and outputs to particular signals within module 120. For example, clock signal CLK of module 120 is coupled to clock input CLK of module 70 (labeled “.CLK”). Output Y of module 120 is coupled to input “signal” (labeled “.signal”) of module 70. During simulation, synchronous assert statement 134 checks the logic state of output Y at the rising edge of clock signal CLK. If output Y is a logic “1” at the rising edge of CLK, synchronous assert statement 134 will flag an error message, as indicated by flag statement 78 in FIG. 4.

FIG. 7 is a waveform diagram illustrating an example of waveforms applied to module 120 during simulation and the signals TEMP and Y generated by the module. At time T0, CLK=0, A=0 and B=1, which makes TEMP=1 and Y=0. At time T1, clock signal CLK transitions from a “0” to a “1”. This is known as a “rising edge” of CLK. Shortly after the rising edge of CLK, inputs A and B switch states. At time T2, A switches from “0” to “1”. At time T3, B switches from “1” to “0”. TEMP remains at “1”. Since A and B may not transition at exactly the same times, as shown by the time difference T3-T2, output Y may temporarily go high, from time T2 to time T3. However, the condition placed on Y in the above example requires Y to be low only at the rising edge of CLK. Since synchronous assert statement 134 checks the logic state of output Y only at the rising edge of CLK, no error flag is generated by flag statement 78 shown in FIG. 4.

However if the non-synchronous assert module shown in FIG. 3 were used, condition statement 56 would be satisfied and the module would flag a false error. With synchronous assert module 70, signal Y does not have to obey condition 82 during the remaining portions of the clock period. This significantly improves the effectiveness and utility of assert checks performed on logic designs at the register-transfer level, prior to logic synthesis.

The synchronous assert module can be implemented as a separate module within an HDL library and instantiated by reference by the other modules in the library, or the synchronous assert module can simply be coded as additional statements within the modules needing an assert check. Alternatively, the logic designer can insert synchronous assert statements or code directly into the HDL specification. Again, the particular condition on which the signal is compared can vary depending on the condition being checked and the various signals involved in that condition.

Although the present invention has been described with reference to preferred embodiments, workers skilled in the art will recognize that changes may be made in form and detail without departing from the spirit and scope of the invention.

What is claimed is:

1. A hardware description language module comprising:
at least one input and output, including a clock input;
a plurality of logic statements that define a function of the module;
a logic signal which is available within the module; and
a synchronous assert check, which checks a state of the logic signal against a condition only during a predefined time window within a period of the clock input.

2. The hardware description language module of claim 1 wherein the time window is an instant in time.

3. The hardware description language module of claim 2 wherein the clock input has a rising edge and a falling edge during the clock period and the instant in time is at one of the rising and falling edges.

4. The hardware description language module of claim 1 and further comprising an error flag statement, which generates an error flag if the logic state matches the condition.

5. A method of testing a hardware description language (HDL) specification which includes a plurality of HDL modules, the method comprising:
(a) applying a test vector to a software model defined by the HDL specification;
(b) simulating a response of the software model, including a response of a logic signal generated by the software model, to the test vector over at least one period of a clock signal; and
(c) checking a state of the logic signal against a condition during only a predefined time window within a period of the clock signal, wherein the predefined time window is less than the clock period; and
(d) generating an error flag if the logic state satisfies the condition during the time window, but not if the logic state satisfies the condition outside of the time window only.

6. The method of claim 5 and further comprising:
(e) inserting a synchronous assert check module into the HDL specification, wherein step (c) comprises receiving the clock signal and the logic signal as inputs to the synchronous assert check module and checking the state of the logic signal against the condition during the predefined time window with the synchronous assert check module.

7. The method of claim 6 and further comprising:
(f) selecting the synchronous assert check module from an HDL library; and
(g) instantiating the synchronous assert check module into a functional module of the HDL specification that generates the logic signal.

8. The method of claim 5 wherein step (c) comprises checking the state of the logic signal against the condition at an instant in time during the period of the clock signal.

9. The method of claim 8 wherein step (c) comprises checking the state of the logic signal against the condition at either a rising edge or a falling edge of the clock signal.

10. The method of claim 5 wherein step (d) comprises generating an error display message.

11. The method of claim 5 wherein the condition is selected from the group comprising a logic high state, a logic low state, a tri-state level and an unknown state.

12. A hardware description language (HDL) module comprising:
at least one input and output;
a plurality of logic statements that define a function of the module;
a clock signal, which is available within the module;
a logic signal, which is available within the module; and
synchronous assert check means for checking a state of the logic signal against a condition only during a predefined time window within a period of the clock input.

13. The HDL module of claim 12 wherein the synchronous assert check means comprises means for generating an error flag if the logic state satisfies the condition during the time window, but not if the logic state satisfies the condition outside of the time window only.

14. The HDL module of claim 12 wherein the synchronous assert check means comprises a synchronous assert check module which is instantiated within the HDL module and has means for receiving the clock signal and the logic signal as inputs to the synchronous assert check module and for checking the state of the logic signal against the condition during the predefined time window.

15. The HDL module of claim 12 wherein the synchronous assert check means comprises means for checking the state of the logic signal against the condition at an instant in time during the period of the clock signal.

16. The HDL module of claim 15 wherein the synchronous assert check means comprises means for checking the state of the logic signal against the condition at either a rising edge or a falling edge of the clock signal.

17. The HDL module of claim 10 wherein the condition is selected from the group comprising a logic high state, a logic low state, a tri-state level and an unknown state.

18. A hardware description language (HDL) library comprising:
a plurality of HDL function modules; and
a synchronous assert check module, which comprises:
a signal input;
a clock input having a clock period; and
a condition statement, which identifies a condition against which a state of the logic signal is compared and a time window within the clock period during which the condition statement is executed, wherein the time window is less than the clock period.

19. The HDL library of claim 18 wherein the synchronous assert check module further comprises an error flag statement which generates an error flag if the state of the logic signal satisfies the condition.
